(19) United States
(12) Patent Application Publication
(10) Pub. No.: US 2026/0150941 A1
(43) Pub. Date: Jun. 4, 2026

(54) Modular Hygienic Storage and Charging System for Personal Devices

(71) Applicant: Olivier Robert, Baardegem (BE)

(72) Inventor: Olivier Robert, Baardegem (BE)

(21) Appl. No.: 18/964,358

(22) Filed: Nov. 30, 2024

(51) Int. Cl. A45C 7/00; A45C 13/00; H02J 7/00

(52) U.S. Cl. CPC A45C 7/005; A45C 13/001; H02J 7/731; H02J 7/855

(57) ABSTRACT

A modular storage and charging system for personal devices is disclosed. The system may be implemented in a suitcase, box, briefcase, pouch, handbag, or other container format and includes an internal power-distribution assembly (e.g., a thermally efficient power strip or charging hub) configured to supply power to one or more devices stored within the container. The container may include fixed and/or adjustable compartments, cable-management features for routing charging cables to devices stored in respective compartments, and an interior visible-light illumination element actuated upon opening. Optional features may include wireless communications functionality, antimicrobial and/or washable liners, ventilation structures, and ultraviolet sanitization components.

### BACKGROUND OF THE INVENTION

Existing storage solutions for personal devices lack comprehensive features addressing hygiene, organization, security, discretion, adaptability, customization, and user convenience, such as automatic lighting and integrated charging systems. An analysis of prior art reveals these shortcomings:

US20170238664A1 (“Accessory or Fashion Item that Charges Various Electronic Devices”): Focuses on a toteable or wearable fashion item configured to charge mobile electronic devices. However, it does not include advanced hygiene optimization, adjustable compartments, automatic lighting, or IoT integration. The absence of hygiene features and modular storage limits its utility for personal devices requiring special handling.

US20100231161A1 (“Apparatus for Storing and Charging Electronic Devices”): Provides an apparatus for conveying and charging portable electronic devices with internal and external electrical interfaces. While it offers charging capabilities, it lacks considerations for hygienic storage, modularity, adjustable compartments, automatic lighting, and IoT integration. It does not address hygiene optimization or the storage needs of diverse personal devices.

US20180295959A1 (“Configurable Organizer System for Handbag, and Modular Storage Compartments for Same”): Introduces a configurable organizer system with modular storage compartments using magnetic connectors. While it offers modularity and adjustable compartments, it lacks charging capabilities, hygiene optimization features such as antimicrobial materials or UV-C sterilization, automatic lighting, and IoT integration. It does not cater to the specific needs of personal devices requiring both hygienic storage and charging.

US20240100207A1 (“System and Device for Sanitizing Personal Use Items”): Describes a system and apparatus for sanitizing personal use items using electromagnetic radiation within an enclosed compartment. Although it addresses hygiene through sanitization, it does not include charging capabilities, adjustable compartments, automatic lighting, or IoT features. Its focus is solely on sanitization without integrating other functionalities such as charging or user convenience features.

### These Existing Solutions Fail to Offer a Holistic System Combining

Secure Storage: Providing safe and discreet storage for personal devices.

Fixed or Adjustable Compartments: Accommodating devices of various sizes and shapes.

Automatic Lighting upon Opening: Enhancing user convenience and visibility.

Integrated Charging Systems: Allowing devices to be charged while stored, which is absent in prior art like US20180295959A1.

Hygiene Optimization: Utilizing features like UV-C sterilization, antimicrobial materials, and washable liners.

Modularity and Customization: Supporting future upgrades and user-specific configurations.

Optional IoT Integration: Enabling remote management and additional functionalities.

Eco-Friendly Materials: Offering environmentally friendly construction options.

Therefore, there is a need for an improved storage solution that integrates all these features to provide a comprehensive and convenient system for personal device storage, privacy, charging, and hygiene.

### SUMMARY OF THE INVENTION

The present invention provides a comprehensive storage and charging solution for personal devices, addressing the shortcomings of existing products by combining multiple innovative features:

Modular Design: Available in various formats and shapes, allowing users to select configurations that suit their preferences.

Compartmentalization: Offers both fixed and adjustable compartments to securely store devices of varying sizes and shapes.

Automatic Lighting upon Opening: Includes a lighting system that activates automatically when the storage system is opened, enhancing visibility and user convenience.

Integrated Charging System: Features versatile charging options, such as wired and wireless technologies, with organized cable management and optional ventilation.

Hygiene Optimization: Utilizes compartmentalization to prevent cross-contamination, with optional features like UV-C sterilization, antimicrobial materials, and washable liners.
Optional Enhancements: Includes features such as IoT integration for remote management, eco-friendly materials, and advanced locking mechanisms.

Adaptability: Designed to accommodate future technological advancements, ensuring long-term utility.

Industrial Applicability: Applicable across industries for storing and charging personal devices, including electronics, medical devices, grooming tools, and other small items requiring secure, hygienic storage and charging.

### DEFINITIONS AND CLARIFICATIONS

To ensure clear understanding and eliminate any ambiguity in the claims, the following definitions are provided within the context of the present invention:

Structure: Refers to the central framework integrated within a container such as a suitcase, box, briefcase, pouch, star-shaped handbag, or other customizable shapes. This structure houses the storage compartments, charging system, and other functional components, ensuring seamless integration and functionality within the overall container.

Compartment: An individual storage space within the structure, each designed to securely hold and organize a single personal device, thereby preventing cross-contamination and maintaining hygiene.

Closure Mechanism: Any device or system used to secure the compartments, ensuring that stored personal devices are kept safe and discreet. This includes mechanical and electronic locking systems such as combination locks, zippers, keys, biometric locks, and IoT-connected locks.

Thermally Efficient Power Strip: A power distribution component integrated into the system, designed to minimize heat generation while providing multiple types of charging sockets (USB, USB-C, conventional, etc.) to charge multiple devices simultaneously without overheating.

IoT Module: An integrated electronic component that enables the storage and charging system to connect to the Internet of Things via wireless protocols like Wi-Fi or Bluetooth Low Energy (BLE). This module facilitates remote communication, control, and management of the system's features through a mobile application.

UV-C Sterilization System: A sanitation feature utilizing ultraviolet type C radiation at approximately 254 nm to disinfect personal devices stored within the compartments. The system includes safety interlocks to prevent UV-C exposure to users when compartments are open.

Antimicrobial Materials: Substances or coatings applied to the interior surfaces of the storage compartments to inhibit the growth and proliferation of microorganisms, enhancing the hygiene of stored personal devices.

Washable Liners: Removable or fixed interior layers within the compartments made from materials that can be easily cleaned, ensuring the maintenance of hygiene standards within the storage system.

Ventilation Control: Mechanisms within the storage system that regulate airflow to prevent overheating of devices during charging, contributing to the longevity and safety of both the storage system and the personal devices.

### DETAILED DESCRIPTION OF THE INVENTION

### Structure and Materials

Formats and Shapes: The storage system is offered in multiple formats, including suitcase, box, briefcase, pouch, star-shaped handbag, and customizable shapes, to meet diverse user needs and preferences. This flexibility ensures that the system can be seamlessly integrated into various types of personal carry items, enhancing its usability and appeal.

Construction Materials: The structure may be made from materials such as composites, metals, plastics, silicone, fabric shells, velvet, quilted fabrics, leather, and future-developed materials. Optionally, eco-friendly materials like recycled or biodegradable substances can be used, offering environmentally friendly construction without imposing additional costs if not desired. The choice of materials ensures durability, aesthetic appeal, and adaptability to different user preferences.

Closure Mechanisms: Multiple closure types are available, including combination locks, zippers, keys, biometric locks, IoT-connected locks, and future-developed mechanisms, ensuring flexibility and security. These mechanisms provide varying levels of security and convenience, catering to different user needs and preferences.

### Compartmentalization

Fixed Compartments: The system includes fixed compartments designed to securely hold personal devices of standard sizes and shapes, providing stable and straightforward storage solutions. Fixed compartments offer ease of use and reliability for storing commonly used devices.

Adjustable Compartments: Alternatively or additionally, the system may feature adjustable compartments that allow users to modify the size and shape of each compartment.

Adjustment mechanisms include, but are not limited to:

Removable Dividers: Inserts that can be added or removed to change compartment sizes.

Expandable Materials: Flexible materials that can stretch or compress.

Mechanical Adjustment Mechanisms: Sliding panels, telescoping sections, or other mechanical means.

Inflatable Components: Air-filled bladders that can expand or contract.

Magnetic Systems: Magnetic dividers that can be repositioned easily.

Enhanced Specificity on Modularity: the modularity of the storage system is achieved through the use of magnetic connectors and snap-fit mechanisms that allow compartments to be easily added, removed, or rearranged without the need for specialized tools. Additionally, the mechanical adjustment mechanisms include telescoping panels and sliding rails that enable users to customize the internal layout dynamically. These specific connectors and adjustment methods provide robust flexibility, allowing the system to adapt to a wide range of device sizes and user preferences.

### Automatic Lighting Upon Opening

Lighting System: The storage system includes an automatic lighting feature that activates upon opening. The lighting system may use LED lights or other suitable technologies to illuminate the interior compartments. This feature enhances visibility, making it easier to locate and access stored devices, especially in low-light conditions.

Power Source: the lighting system is powered by the system's internal power source, which may be a rechargeable battery or connected through the detachable power cord. This ensures that the lighting system operates efficiently without draining the main charging system's power.

User Convenience and Safety: The automatic lighting enhances visibility of the contents, aiding users in locating devices, especially in low-light conditions, and contributes to safety by reducing the need to search blindly within compartments.

### Integrated Charging System

Versatile Charging Options: A thermally efficient charging system offers multiple charging options, including: Wired Charging: USB, USB-C, and conventional sockets/Wireless Charging: Inductive charging technologies/Future-Developed Charging Technologies: The system is designed to accommodate new charging methods as they become available. This versatility ensures compatibility with a wide range of personal devices and future charging standards.

Detachable Power Cord with Discreet Storage: The power cord is detachable and can be stored in a designated compartment, enabling discreet charging while the system is closed and connected to an external power outlet. This feature maintains the system's aesthetic appeal and convenience.

Rechargeable Battery Option: An optional rechargeable battery allows for portable charging without the need for an external power source, enhancing discretion and convenience. This feature is particularly useful for on-the-go charging needs.

Organized Cable Management: Each compartment includes openings for charging cables, ensuring organized cable management and preventing tangling or damage to cords. This organization maintains the system's cleanliness and functionality.

Optional Ventilation System: An optional ventilation system prevents overheating during charging, enhancing safety and prolonging the lifespan of stored devices. Proper ventilation ensures that devices remain in optimal condition during use.

### Hygiene Optimization

Compartmentalized Design: Each device is stored in an individual compartment, whether fixed or adjustable, preventing cross-contamination and maintaining cleanliness. This design is crucial for devices that require sanitary storage conditions.

Optional UV-C Sterilization System: Integrated into compartments as an optional feature, the UV-C sterilization system provides automatic disinfection between uses, enhancing hygiene. This system ensures that stored devices remain sanitized without manual intervention.

Optional Washable Liners: Removable or fixed washable liners made from materials that can be easily cleaned are offered as an option, providing an extra layer of protection and facilitating maintenance. Washable liners simplify the cleaning process, maintaining the system's hygiene standards.

Optional Antimicrobial Materials: The interior surfaces of the compartments can optionally be made from or coated with antimicrobial materials to inhibit microbial growth, providing enhanced hygiene without significantly increasing complexity or cost. This feature adds an additional layer of protection against contamination.

### Optional IoT Integration

IoT Connectivity Module: When equipped with the optional IoT integration, the system includes a connectivity module enabling communication with mobile devices. This module allows users to manage the system remotely, enhancing functionality and convenience.

Remote Access and Control: Users can remotely manage storage conditions, security features, charging schedules, and lighting via a mobile application. This feature provides enhanced control and monitoring capabilities, increasing the system's utility.

Features Supported by IoT Integration: Temperature Regulation: IoT-enabled temperature control prevents microbial growth and safeguards stored devices/Ventilation Control: Remote activation of the optional ventilation system enhances safety during charging and storage/Access Logging: The system can log access and usage data for security and user convenience/Security Management: Remote locking and unlocking of the system enhance security and discretion/Lighting Control: Users can remotely control the lighting system, including adjusting brightness or setting schedules/Software Security Measures: Data encryption and secure authentication protocols protect user data, ensuring the system's security.

### Discretion and Accessibility

Secure Locking Mechanisms: The system incorporates secure locking mechanisms, including combination locks, biometric locks, and, when equipped, IoT-connected locks. These mechanisms ensure that stored personal devices are protected from unauthorized access.

Design for Quick Access: The system supports quick access to devices while maintaining privacy, with ergonomic designs and intuitive compartment layouts. This design ensures that users can efficiently retrieve their devices without compromising discretion.

### Adaptability and Customization

Modular Design for Future Upgrades: The system's modularity allows for future enhancements, such as the addition of new features or adaptation to new devices. This design ensures that the system remains relevant and functional as technology evolves.

Optional Features: Users can choose optional features like fixed or adjustable compartments, automatic lighting upon opening, IoT integration, antimicrobial materials, UV-C sterilization, washable liners, and eco-friendly materials based on their preferences and needs.

This flexibility allows users to customize the system to suit their specific requirements.

### INDUSTRIAL APPLICABILITY

The Modular Hygienic Storage and Charging System is designed for versatile use across multiple industries, providing secure and hygienic storage and charging solutions for a wide range of personal devices. Its adaptability makes it suitable for:

Electronics: Safeguarding and charging smartphones, tablets, laptops, and other personal electronic devices, ensuring organized cable management and preventing device damage.

Medical Devices: Providing sterile storage and charging for portable medical equipment such as blood glucose monitors, portable ventilators, and other critical healthcare devices, integrating UV-C sterilization to maintain device hygiene.

Grooming Tools: Organizing and charging personal grooming devices like electric razors, trimmers, and hair styling tools, ensuring convenience and hygiene through compartmentalization and antimicrobial materials.

Other Small Items: Accommodating various small personal items, including jewelry, cosmetics, and portable gaming devices, requiring secure, hygienic storage and charging solutions.

This broad applicability not only addresses diverse user needs but also positions the system as a comprehensive solution adaptable to evolving technological advancements and industry-specific requirements.

### DESCRIPTION OF THE DRAWINGS

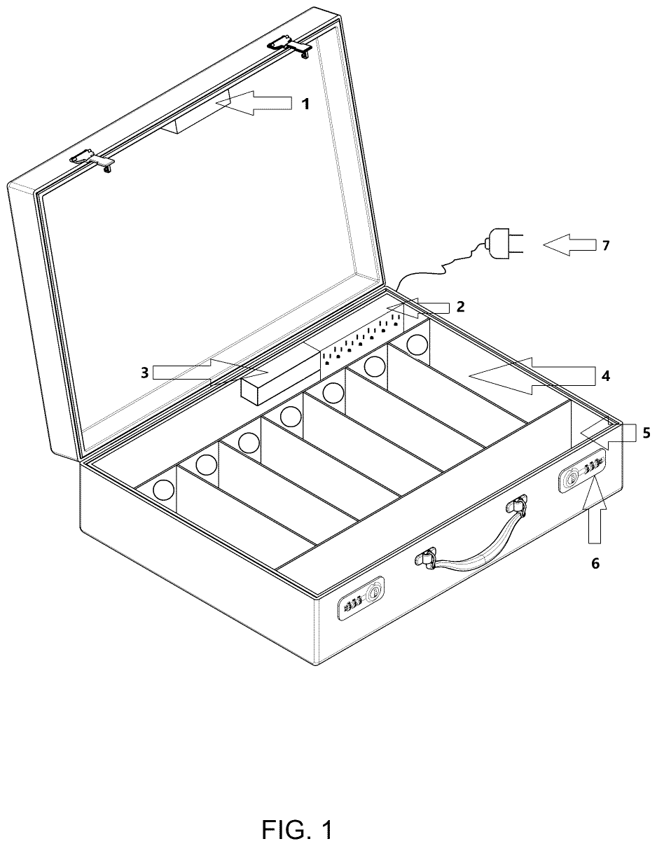

### FIGS. 1-8 Illustrate Various Embodiments of the Modular Hygienic Storage and Charging System for Personal Devices, each Showcasing Different Container Formats and Configurations

FIG. 1: Perspective view of the open briefcase format, illustrating the internal compartments, IoT module and LED lighting (Arrow 1), and the connected detachable power cord (Arrow 7).

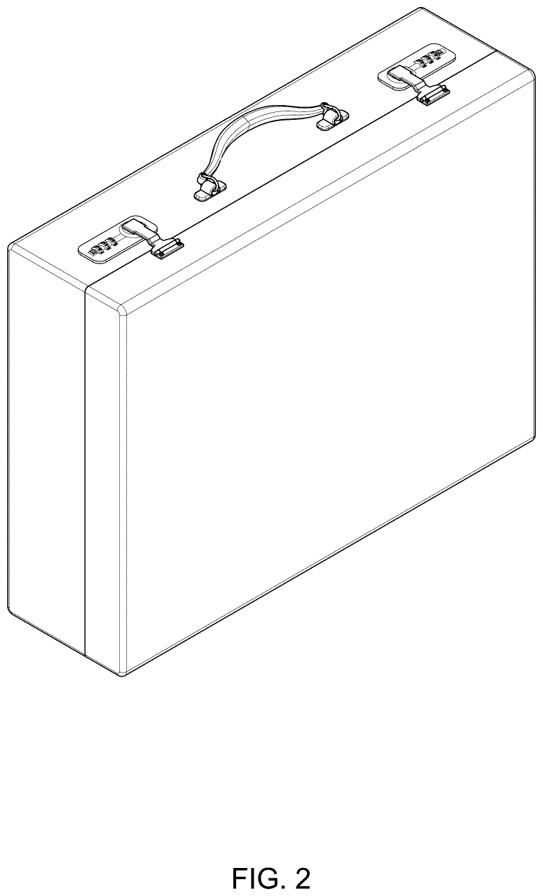

FIG. 2: Perspective view of the closed carry-on suitcase format, highlighting the closure mechanisms (Arrow 6).

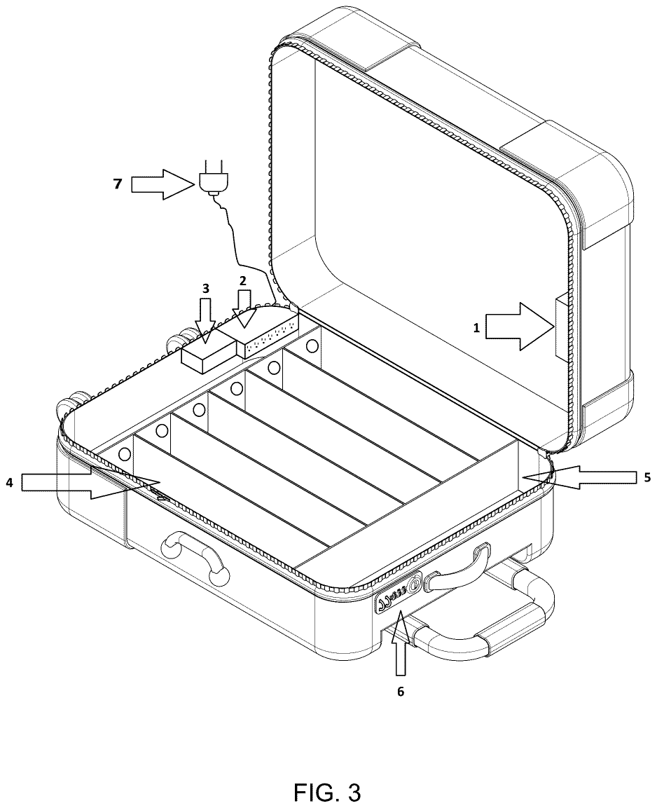

FIG. 3: Perspective view of the open carry-on suitcase, showing internal components including the thermally efficient power strip (Arrow 2) and compartments with cable openings (Arrow 4).

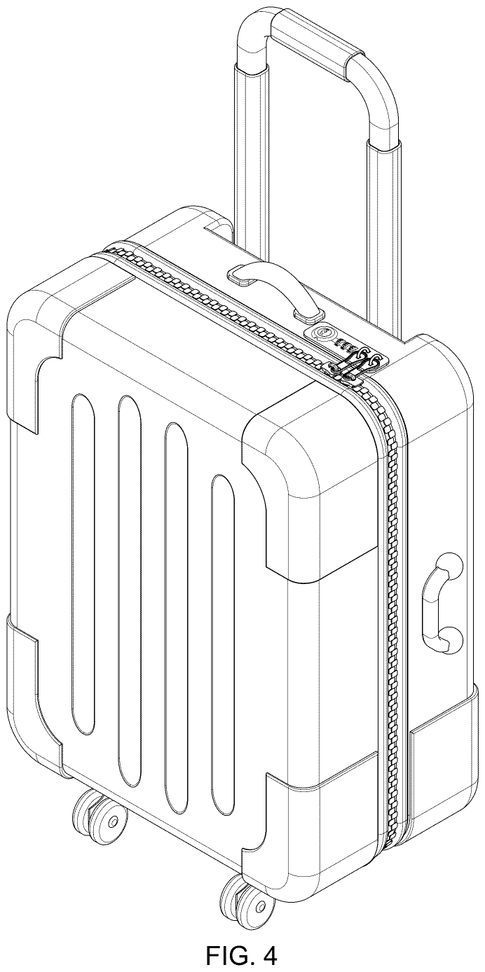

FIG. 4: Perspective view of the closed carry-on suitcase, emphasizing the system's discreet design and secure closure mechanisms.

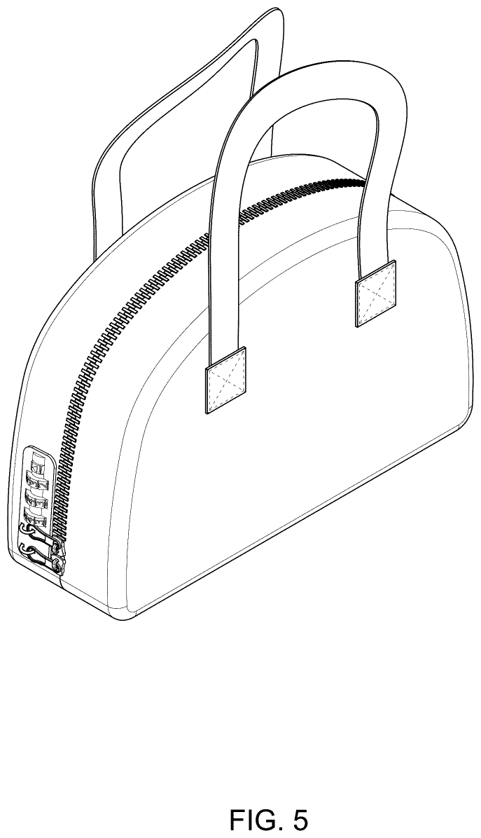

FIG. 5: Perspective view of the closed small handbag format, demonstrating the system's versatility in different container types.

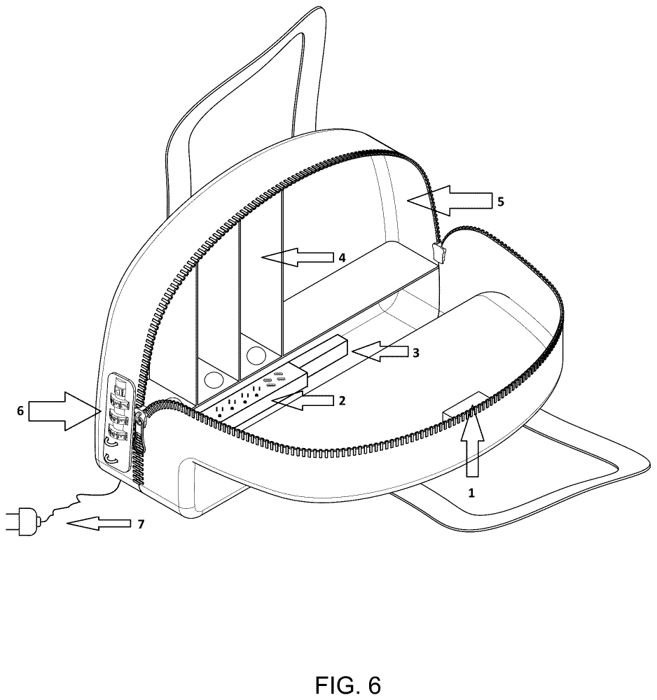

FIG. 6: Perspective view of the open small handbag, displaying organized compartments and the IoT module and LED lighting (Arrow 1).

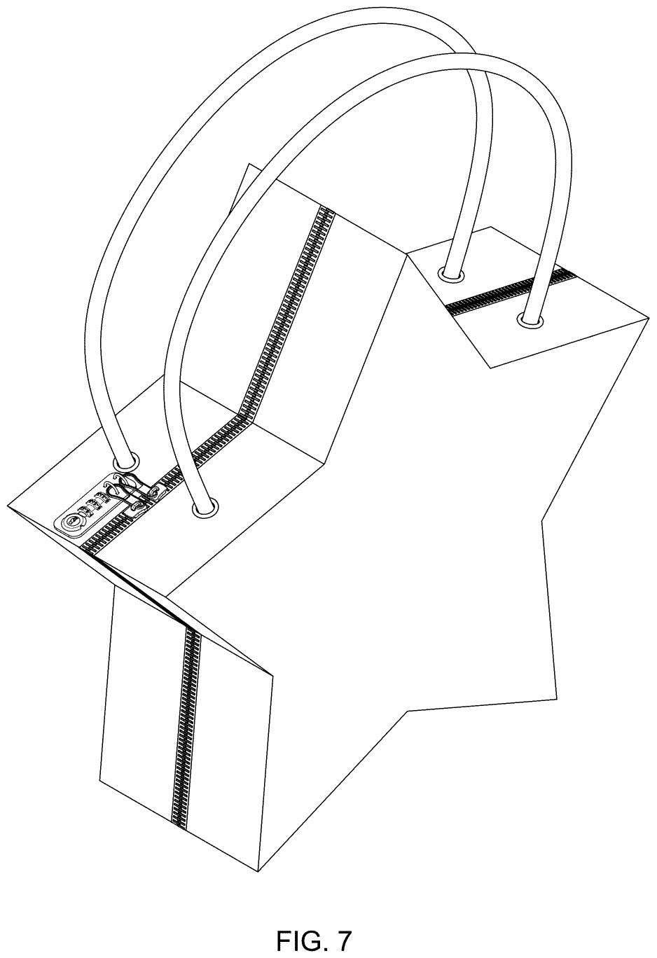

FIG. 7: Perspective view of the closed star-shaped handbag, illustrating the system's customization capabilities.

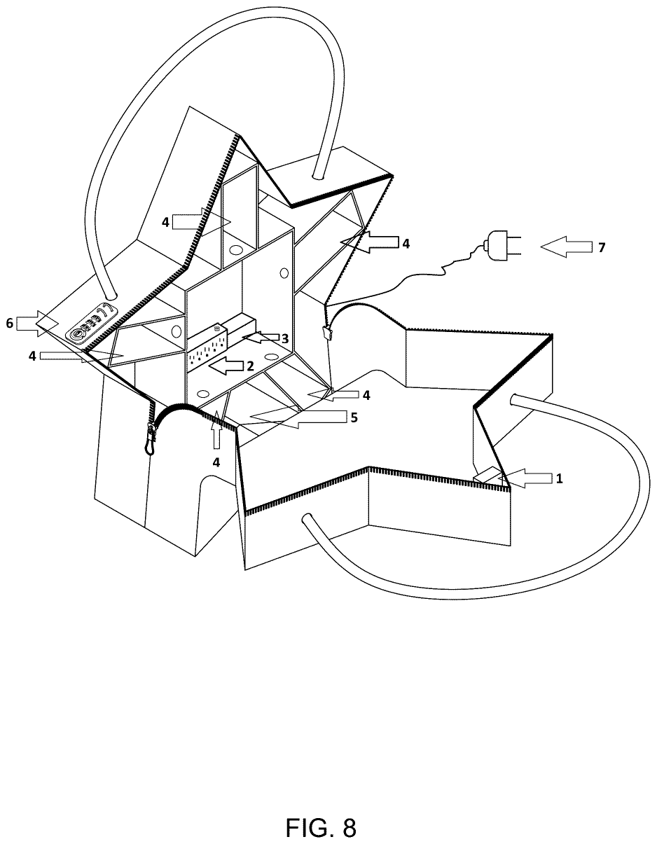

FIG. 8: Perspective view of the open star-shaped handbag, showing the interior layout with adjustable compartments and the connected detachable power cord (Arrow 7).

### ARROWS 1-7 CORRESPOND TO THE FOLLOWING COMPONENTS WITHIN THE SYSTEM

Arrow 1: IoT module and LED lighting.
Arrow 2: Thermally efficient power strip.
Arrow 3: Detachable battery module.
Arrow 4: Compartments with cable openings.
Arrow 5: Accessories and power cord compartment.
Arrow 6: Closure system.
Arrow 7: Connected detachable power cord.

1. A modular storage and charging system for personal devices, comprising:
a structure integrated within a portable container in the form of one of a suitcase, box, briefcase, pouch, star-shaped container, or handbag;
one or more compartments within the structure, each of the one or more compartments sized and configured to securely store individual personal devices and being fixed or adjustable;
a closure mechanism configured to secure the one or more compartments;
a charging system integrated within the structure, including a thermally efficient power strip having multiple types of charging sockets; and
a cable opening formed in each of the one or more compartments.

2-17. (canceled)

18. The system of claim 1, wherein the closure mechanism is at least one of a combination lock, a zipper, a key, a biometric lock, or an IoT-connected lock.

19. The system of claim 1, wherein the charging system includes at least one of each of a USB socket, a USB-C socket, and a conventional socket.

20. The system of claim 1, further comprising at least one of magnetic connectors, snap-fit mechanisms, telescoping panels, or sliding rails to enable reconfiguration and/or layout customization of the one or more compartments.

21. The system of claim 1, further comprising a UV-C sterilization system integrated into at least one of the one or more compartments, the UV-C sterilization system comprising:
one or more UV-C lamps configured to emit UV-C type radiation at a wavelength around 254 nm, and
a safety interlock configured to deactivate the one or more UV-C lamps when the at least one of the one or more compartments is opened.

22. The system of claim 21, wherein the UV-C sterilization system further comprises:
reflective surfaces within the at least one of the one or more compartments, and
control circuitry configured to schedule or automatically activate the UV-C sterilization system post-use of a personal device.

23. The system of claim 1, further comprising at least one of:
washable liners placed in the one or more compartments, or
antimicrobial materials applied to interior surfaces of the one or more compartments and configured to inhibit microbial growth.

24. The system of claim 1, further comprising an IoT module configured to enable remote access and control, the IoT module supporting at least one of:
internal temperature regulation through sensors and actuators,
ventilation control,
access logging with timestamps,
remote locking and unlocking and unauthorized access notifications,
internal lighting adjustments, or
secure data encryption and authentication.

25. The system of claim 1, further comprising:
a ventilation system configured to prevent overheating during charging; and
temperature control mechanisms configured to maintain optimal storage conditions.

26. The system of claim 1, wherein the charging system is powered by a detachable battery.
